(19) United States
(12) Patent Application Publication
(10) Pub. No.: US 2018/0281533 A1
(43) Pub. Date: Oct. 4, 2018

(54) MONITORING DEVICE AND TIRE AIR PRESSURE MONITORING SYSTEM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventor: Makoto Saburi, Yokkaichi, Mie (JP)

(21) Appl. No.: 15/765,312

(22) PCT Filed: Oct. 6, 2016
(86) PCT No.: PCT/JP2016/079748

§ 371 Date: Apr. 2, 2018

(30) Foreign Application Priority Data
Oct. 9, 2015 (JP) 2015-201040

(51) Int. Cl. B60C 23/04; B60C 23/00

(52) U.S. Cl. CPC B60C 23/0416; B60C 23/0435; B60C 23/003

(57) ABSTRACT

A monitoring device receives air pressure signals transmitted from a plurality of detection devices that are respectively provided in tires of a vehicle and wirelessly transmit air pressure signals each including a respective identifier and air pressure information for a respective tire. A storage unit of the monitoring device stores tire positions at which the tires are provided and identifiers of detection devices in correspondence with each other. The monitoring device includes a request signal transmission unit that transmits, a plurality of times, a request signal requesting an identifier to at least one tire position, and an identifier reception unit that receives identifiers that are transmitted from a detection device. The monitoring device specifies the identifier of the detection device provided at the one tire position based on the identifiers that were transmitted in accordance with the request signal, and updates the identifier stored by the storage unit.

### CROSS-REFERENCE TO RELATED APPLICATIONS

This application is the U.S. national stage of PCT/JP2016/079748 filed Oct. 6, 2016, which claims priority of Japanese Patent Application No. JP 2015-201040 filed Oct. 9, 2015.

### TECHNICAL FIELD

The present disclosure relates to a monitoring device and a tire air pressure monitoring system.

This application claims priority based on Japanese Patent Application No. 2015-201040 filed on Oct. 9, 2015, and the entire contents of this Japanese patent application are hereby incorporated herein by reference.

### BACKGROUND

There is a tire air pressure monitoring system (TPMS: Tire Pressure Monitoring System) that detects the air pressure of tires provided in a vehicle and issues a warning or the like to a user if a detected air pressure is abnormal. The tire air pressure monitoring system includes a detection device that detects the air pressure of a tire and uses UHF band radio waves to wirelessly transmit an air pressure signal pertaining to the detected air pressure, and a monitoring device that receives the air pressure signal that was wirelessly transmitted by the detection device, and monitors the tire air pressure based on the received air pressure signal. The detection device is provided in each of front-right, front-left, rear-right, and rear-left tires, and wirelessly transmits an air pressure signal that includes air pressure information obtained by detection and an identifier for identifying the detection device. The monitoring device is provided on the vehicle body, and receives the air pressure signals transmitted by the detection devices. The monitoring device stores the identifiers given to the tires in a memory in association with the four tire positions at which the tires are provided in the vehicle. The monitoring device can recognize the air pressure of the tire provided at each of the tire positions by comparing the identifiers included in the received air pressure signals with the identifiers stored in the memory.

Incidentally, in order to obtain a uniform wear state for four tires, tire rotation for interchanging the positions of the tires provided in the vehicle with each other is generally performed. JP 2004-58964A discloses a tire air pressure monitoring system in which even if tire rotation is performed, the identifiers that correspond to the tire positions can be updated and stored in a memory. In this tire air pressure monitoring system, request signals that request identifiers from the detection devices provided in the tires are transmitted from antennas that are provided in the vicinity of the tire positions. The transmission range of the request signal transmitted from each antenna includes only one corresponding detection device. The monitoring device receives the identifiers that are transmitted from the detection devices in accordance with the requests, confirms that each of the received identifiers matches any one of the four identifiers that are already registered in the memory, and then stores the received identifiers in the memory in association with the corresponding tire positions. In the tire air pressure monitoring system according to JP 2004-58964A, even if tire rotation is performed, the correspondence relationship between the tire positions and the identifiers can be automatically updated.

### SUMMARY

A monitoring device according to an aspect of the present disclosure is a monitoring device that monitors air pressures of tires, the monitoring device receiving air pressure signals transmitted from a plurality of detection devices that are respectively provided in a plurality of tires of a vehicle and wirelessly transmit air pressure signals each including a respective identifier and air pressure information obtained by detecting an air pressure of a respective tire, the monitoring device including: a storage unit that stores a plurality of tire positions at which the plurality of tires are respectively provided and identifiers of the detection devices provided at the tire positions in correspondence with each other; a request signal transmission unit that transmits, a plurality of times, a request signal requesting an identifier of a detection device to at least one of the tire positions; an identifier reception unit that receives an identifier that was transmitted by a detection device in accordance with the request signal; a specification unit that specifies an identifier of the detection device provided at the at least one tire position to which the request signal was transmitted, based on a plurality of identifiers that were transmitted by the detection device in accordance with the request signal that was transmitted a plurality of times; and an updating unit that updates the identifier that is stored by the storage unit in correspondence with the at least one tire position to the identifier that was specified by the specification unit.

A tire air pressure monitoring system according to an aspect of the present disclosure includes: a plurality of detection devices that are respectively provided in a plurality of tires of a vehicle and wirelessly transmit air pressure signals each including a respective identifier and air pressure information obtained by detecting an air pressure of a respective tire; and the above-described monitoring device, wherein the monitoring device receives the air pressure signals transmitted by the plurality of detection devices and monitors air pressures of the tires.

Note that the disclosure of the present application can not only be realized as a monitoring device and a tire air pressure monitoring system that include these characteristic processing units, but can also be realized as a tire air pressure monitoring method whose steps are these characteristic processes, or be realized as a program for causing a computer to execute these steps. Also, the invention can be realized as a semiconductor integrated circuit that realizes part of or the entirety of the tire air pressure monitoring system or the monitoring device, or be realized as another system that includes the tire air pressure monitoring system or the monitoring device.

### BRIEF DESCRIPTION OF THE DRAWINGS

FIG. 1 is a schematic diagram showing an example of the configuration of a tire air pressure monitoring system according to a first embodiment of the present disclosure.

FIG. 2 is a block diagram showing an example of a configuration of a monitoring device.

FIG. 3 is a conceptual diagram showing an example of a sensor ID table.

FIG. 4 is a block diagram showing an example of a configuration of a detection device.

FIG. 5 is a flowchart showing a sensor ID update processing procedure according to the first embodiment.

FIG. 6 is a flowchart showing a processing procedure of a subroutine pertaining to sensor ID consistency determination processing.

FIG. 7 is a table for describing a sensor ID determined state.

FIG. 8 is a table for describing a correspondence undetermined state for tire positions and sensor IDs.

FIG. 9 is a table for describing a sensor ID undetermined state.

FIG. 10 is a table showing timings at which statistical processing is to be performed.

FIG. 11 is a flowchart showing a processing procedure of a subroutine pertaining to statistical processing for specifying and updating sensor IDs.

FIG. 12 is a conceptual diagram showing an example of a sensor ID table according to a second embodiment.

FIG. 13 is a flowchart showing a transmission intensity adjustment processing procedure according to the second embodiment.

FIG. 14 is a flowchart showing the transmission intensity adjustment processing procedure according to the second embodiment.

### DETAILED DESCRIPTION OF THE PREFERRED EMBODIMENTS

In the tire air monitoring system in the background technology described above, if some tires are replaced with other tires along with detection devices, or a detection device is replaced, the monitoring device receives an identifier that is different from the identifiers that are already registered in the memory, and therefore the identifiers cannot be updated.

Also, there is a risk that a request signal that was transmitted to the detection device of one tire is received not only by that detection device, but also by the detection device of another tire, and that identifiers will be transmitted from multiple detection devices as a result, and there are cases where the correspondence relationship between the tire positions and the identifiers is mistakenly updated even though tire rotation has not been performed.

Also, if identifiers transmitted from detection devices that correspond to the respective tire positions are received, it is conceivable to simply register the identifiers in association with the respective tire positions. However, there are cases where a detection device provided in a tire of another adjacent vehicle responds to a request signal, and transmits the identifier thereof to the monitoring device, and there is a risk that the identifier of the detection device provided in the other vehicle will be mistakenly used when performing updating.

An object of the present disclosure is to provide a monitoring device and a tire air pressure monitoring system that can unmistakingly update the identifiers of the detection devices provided at the respective tire positions.

### Effects of Disclosure

According to the present disclosure, it is possible to provide a tire air pressure monitoring system and a detection device that can unmistakingly update the identifiers of the detection devices provided at the respective tire positions.

### Description of Embodiments of Disclosure

First, aspects for carrying out the present disclosure will be described. Also, at least portions of the embodiments described below may be combined as desired.

(1) A monitoring device according to an aspect of the present disclosure is a monitoring device that monitors air pressures of tires, the monitoring device receiving air pressure signals transmitted from a plurality of detection devices that are respectively provided in a plurality of tires of a vehicle and wirelessly transmit air pressure signals each including a respective identifier and air pressure information obtained by detecting an air pressure of a respective tire, the monitoring device including: a storage unit that stores a plurality of tire positions at which the plurality of tires are respectively provided and identifiers of the detection devices provided at the tire positions in correspondence with each other; a request signal transmission unit that transmits, a plurality of times, a request signal requesting an identifier of a detection device to at least one of the tire positions; an identifier reception unit that receives an identifier that was transmitted by a detection device in accordance with the request signal; a specification unit that specifies an identifier of the detection device provided at the at least one tire position to which the request signal was transmitted, based on a plurality of identifiers that were transmitted by the detection device in accordance with the request signal that was transmitted a plurality of times; and an updating unit that updates the identifier that is stored by the storage unit in correspondence with the at least one tire position to the identifier that was specified by the specification unit.

In this aspect, the request signal transmission unit transmits the request signal to at least one tire position. The detection device provided in the tire at that tire position receives the request signal and transmits its identifier to the monitoring device. However, there are cases where a detection device at another tire position or another location or a detection device of another vehicle also receives the request signal. In this case, the detection device of the other tire provided or arranged at a location other than the one tire position transmits an identifier to the monitoring device.

In view of this, the request signal transmission unit transmits the request signal to the tire position multiple times, and the identifier reception unit receives multiple identifiers that are transmitted in accordance with the request signals. The specification unit of the monitoring device then specifies the identifier that corresponds to the tire position based on the received identifiers. In other words, the monitoring device specifies the identifier that is statistically likely to correspond to the tire position based on the identifiers. The identifiers that correspond to the other tire positions can also be specified in a similar manner. If the specification unit has specified an identifier, the updating unit updates the identifier stored by the storage unit with the specified identifier.

Accordingly, even if tire rotation or tire replacement has been performed, or even if an identifier transmitted by another vehicle has been received, it is possible to unmistakingly specify the identifiers that correspond to the tire positions, and to unmistakingly update the identifiers stored by the storage unit.

Note that in the present disclosure, the monitoring device performs specification and updating with respect to the identifier that corresponds to at least one tire position, and it is not necessarily required that updating is performed for the identifiers that correspond to all of the tire positions.

(2) A configuration is preferable in which in a case where one identifier appears a predetermined percentage of the time or more among the received plurality of identifiers, the specification unit specifies the one identifier as the identifier of the detection device provided at the at least one tire position at which the request signal was transmitted.

In this aspect, if one identifier appears a predetermined percentage of the time or more among the received plurality of identifiers, that is to say if the most frequent identifier appears the predetermined percentage of the time or more, the specification unit of the monitoring device specifies that identifier as the identifier that corresponds to the tire position, and updating is performed. By specifying the identifier that is the most frequent and appears the predetermined percentage of the time, it is possible to more precisely specify the identifier that corresponds to the tire position. The identifiers that correspond to the other tire positions can also be specified precisely and updated in a similar manner.

(3) A configuration is preferable in which the request signal includes a first request signal and a second request signal, the monitoring device further includes a determination unit that determines, in a case where the request signal transmission unit transmitted the first request signal, whether or not an identifier received by the identifier reception unit matches the identifier that is stored by the storage unit in correspondence with the at least one tire position, the request signal transmission unit transmits the second request signal to the at least one tire position in a case where the determination unit determines a non-match, and the specification unit specifies the identifier of the detection device provided at the least one tire position based on the plurality of identifiers that were transmitted by the detection device in accordance with at least one of the first request signal and the second request signal.

In this aspect, the monitoring device transmits the first request signal, and the determination unit of the monitoring device determines whether or not the received identifier matches the identifier stored by the storage unit in correspondence with the tire position. The monitoring device then transmits the second request signal to a tire position for which the identifiers did not match, receives additional identifiers, specifies the identifier that corresponds to the tire position, and performs updating. It is sufficient that the second request signal of this aspect is transmitted at least one time.

(4) A configuration is preferable in which the monitoring device further includes a switch state determination unit that determines whether or not an ignition switch of the vehicle is in an on state, and the request signal transmission unit transmits the second request signal in a case where the ignition switch is in the on state and the determination unit determined a non-match.

According to this aspect, if the received identifier does not match the identifier stored by the storage unit in correspondence with the tire position, and the ignition switch is in the on state, the monitoring device executes processing for specifying and updating the identifier at the tire position for which the identifiers did not match.

(5) A configuration is preferable in which the monitoring device further includes a traveling state determination unit that determines whether or not the vehicle is traveling, and the request signal transmission unit transmits the second request signal in a case where the vehicle is traveling and the determination unit determined a non-match.

According to this aspect, if the received identifier does not match the identifier stored by the storage unit in correspondence with the tire position, and the vehicle is traveling, the monitoring device executes processing for specifying and updating the identifier at the tire position for which the identifiers did not match.

(6) A configuration is preferable in which the request signal transmission unit transmits the first request signal to each of the plurality of tire positions, the identifier reception unit receives a plurality of identifiers that were transmitted by the plurality of detection devices in accordance with the first request signal, the determination unit makes a first determination for determining whether or not a correspondence relationship between the plurality of tire positions to which the first request signal was transmitted and the plurality of identifiers that were received by the identifier reception unit matches a correspondence relationship between the plurality of tire positions and the identifiers stored by the storage unit, and makes a second determination for determining whether or not each of the plurality of identifiers received by the reception unit matches any of the plurality of identifiers stored by the storage unit, and the request signal transmission unit transmits the second request signal at a timing that is in accordance with determination results of the first determination and the second determination.

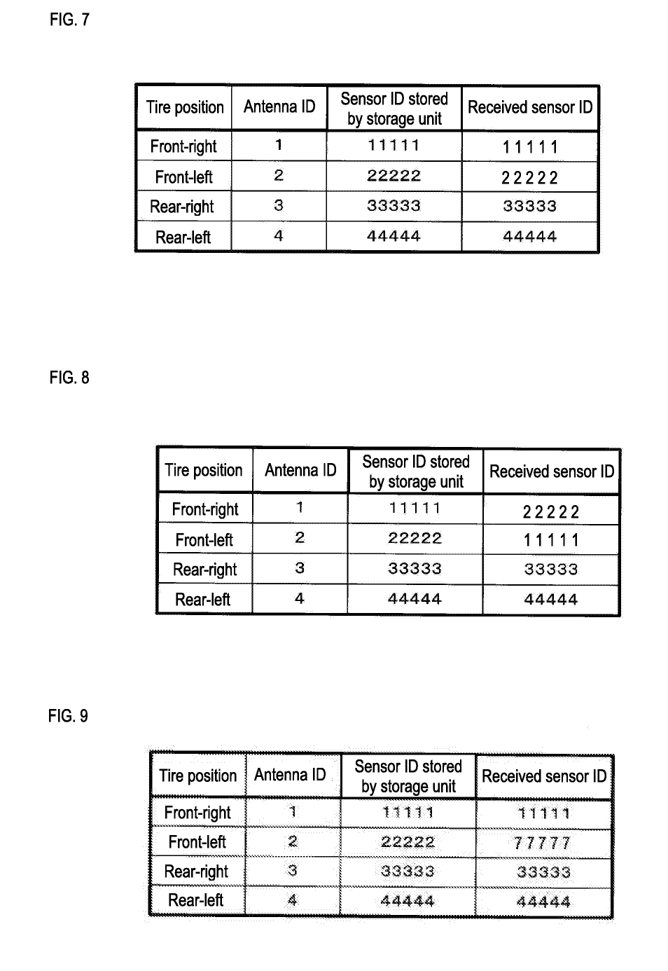

According to this aspect, in the first determination, the determination unit determines whether or not the identifiers stored by the storage unit and the received identifiers all match for each of the tire positions. For example, in the case where the storage unit stores “11111”, “22222”, “33333”, and “44444” as the identifiers that correspond to the front-right, front-left, rear-right, and rear-left tire positions, and the identifiers “11111”, “22222”, “33333”, and “44444” are received from the detection devices provided at the front-right, front-left, rear-right, and rear-left tire positions, the determination unit determines that all of the identifiers match (see FIG. 7). However, in the case where the identifiers “22222”, “11111”, “33333”, and “44444” are received from the detection devices provided at the front-right, front-left, rear-right, and rear-left tire positions, the determination unit determines a non-match (see FIG. 8).

In the second determination, the determination unit determines whether or not the received identifiers match the identifiers stored by the storage unit, regardless of the correspondence relationship with the tire position. For example, in the case where the storage unit stores “11111”, “22222”, “33333”, and “44444” as the identifiers that correspond to the front-right, front-left, rear-right, and rear-left tire positions, and the identifiers “22222”, “11111”, “33333”, and “44444” are received from the detection devices provided at the front-right, front-left, rear-right, and rear-left tire positions, the determination unit determines a match.

Note that in the case where the storage unit stores “11111”, “22222”, “33333”, and “44444” as the identifiers that correspond to the front-right, front-left, rear-right, and rear-left tire positions, and the identifiers “11111”, “77777”, “33333”, and “44444” are received from the detection devices provided at the front-right, front-left, rear-right, and rear-left tire positions, the determination unit a non-match in both the first determination and the second determination.

According to the first determination and the second determination, it is possible to identify the possibility that there is a state in which the tire position has not changed, a state where tire rotation has been performed, a state where detection device replacement or tire replacement has been performed, a state where an identifier was received from a detection device of another vehicle, or the like. By identifying these states, it is possible to perform identifier specification processing at a timing that is suited to the respective situations in which the identifiers did not match.

(7) A configuration is preferable in which the monitoring device further includes a switch state determination unit that determines whether or not an ignition switch of the vehicle is in an on state, and the request signal transmission unit transmits the second request signal in a case where the ignition switch is in the on state, a determination result of the first determination a non-match, and a determination result of the second determination is a match.

According to this aspect, if the determination result of the first determination is a non-match, and the determination result of the second determination is a match, there is no possibility that a detection device was replaced, a tire was replaced, or an identifier was received from another vehicle, and there is a possibility that tire rotation was performed. In this case, it is envisioned that at least the monitoring device received identifiers transmitted by the detection devices provided in the tires of the own vehicle, regardless of the correspondence relationship with the tire position. In opposite terms, it is possible to exclude the possibility that an identifier transmitted by another vehicle was received. Accordingly, identifier specification processing can be performed even if the vehicle is stopped. In view of this, the monitoring device performs identifier specification processing when the ignition switch is in the on state. According to this aspect, it is possible to unmistakingly specify and update the identifiers of the tire positions before the vehicle starts to travel.

(8) A configuration is preferable in which the monitoring device further includes a traveling state determination unit that determines whether or not the vehicle is traveling, and the request signal transmission unit transmits the second request signal in a case where the vehicle is traveling and a determination result of the first determination or the second determination is a non-match.

According to this aspect, if the determination result of the first determination or the second determination is a non-match, for example if the determination results of the first and second determinations are a non-match, there is a possibility that tire replacement was performed or that an identifier transmitted by another vehicle was received. In this case, it is not possible to exclude the possibility that an identifier transmitted by another vehicle was received while the vehicle was stopped. In view of this, the monitoring device performs identifier specification processing while the vehicle is traveling. According to this aspect, it is possible to unmistakingly specify and update the identifiers of the tire positions by performing identifier specification processing while the vehicle is traveling.

(9) A tire air pressure monitoring system according to an aspect of the present disclosure includes: a plurality of detection devices that are respectively provided in a plurality of tires of a vehicle and wirelessly transmit air pressure signals each including a respective identifier and air pressure information obtained by detecting an air pressure of a respective tire; and the monitoring device according to any one of aspects (1) to (8), wherein the monitoring device receives the air pressure signals transmitted by the plurality of detection devices and monitors air pressures of the tires.

In this aspect, similarly to aspect (1), even if tire rotation, detection device replacement, or tire replacement has been performed, or even if an identifier transmitted by another vehicle has been received, it is possible to unmistakingly specify and update the identifiers that correspond to the tire positions.

### Detailed Description of Embodiments of Disclosure

Specific examples of a tire air pressure monitoring system according to embodiments of the present disclosure will be described below with reference to the drawings. Note that the present disclosure is not limited to these examples, but rather is indicated by the scope of the claims, and all changes that come within the meaning and range of equivalence of the claims are intended to be embraced therein.

### First Embodiment

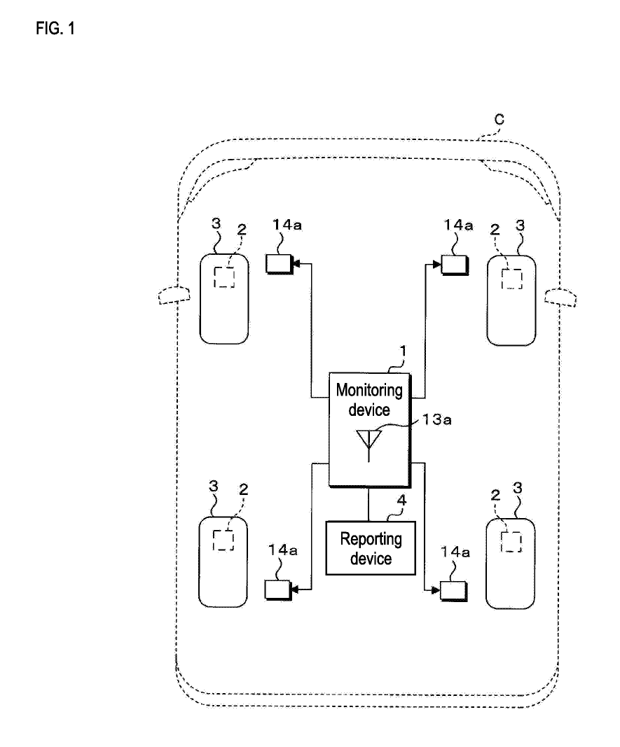

FIG. 1 is a schematic diagram showing an example of the configuration of a tire air pressure monitoring system according to a first embodiment of the present disclosure. The tire air pressure monitoring system of the first embodiment includes a monitoring device 1 provided at an appropriate location on a vehicle body, detection devices 2 that are respectively provided on the wheels of tires 3 mounted to a vehicle C, and a reporting device 4. In the tire air pressure monitoring system of the first embodiment, the monitoring device 1 acquires the air pressure of the tires 3 by performing wireless communication with the detection devices 2, and the reporting device 4 issues a report in accordance with the acquired air pressures. LF (Low Frequency) transmission antennas 14a that correspond to the tires 3 are connected to the monitoring device 1. For example, the LF transmission antennas 14a are provided in front-right, front-left, rear-right, and rear-left portions of the vehicle C. The monitoring device 1 uses LF band radio waves from the LF transmission antennas 14a to transmit to each of the detection devices 2 a request signal that requests air pressure information. In accordance with the request signal from the monitoring device 1, the detection devices 2 detect the air pressures of the tires 3 and use UHF-band (Ultra High Frequency-band) radio waves to transmit an air pressure signal that includes air pressure information obtained by detection and a respective sensor ID (identifier) to the monitoring device 1. Furthermore, the detection devices 2 each have a function of periodically detecting the air pressure of the tire 3 and voluntarily transmitting the air pressure signal to the monitoring device 1.

The monitoring device 1 also includes an RF reception antenna 13a, uses the RF reception antenna 13a to receive air pressure signals transmitted by the detection devices 2, and acquires air pressure information regarding the tires 3 from the air pressure signals. Note that the LF band and the UHF band are examples of the radio wave bands used when performing wireless communication, and the radio wave bands are not necessarily limited to these examples. The reporting device 4 is connected to the monitoring device 1 via a communication line, and the monitoring device 1 transmits the acquired air pressure information to the reporting device 4. The reporting device 4 receives the air pressure information transmitted by the monitoring device 1, and reports the air pressures of the tires 3. Also, the reporting device 4 issues a warning if the air pressure of a tire 3 is below a predetermined threshold value.

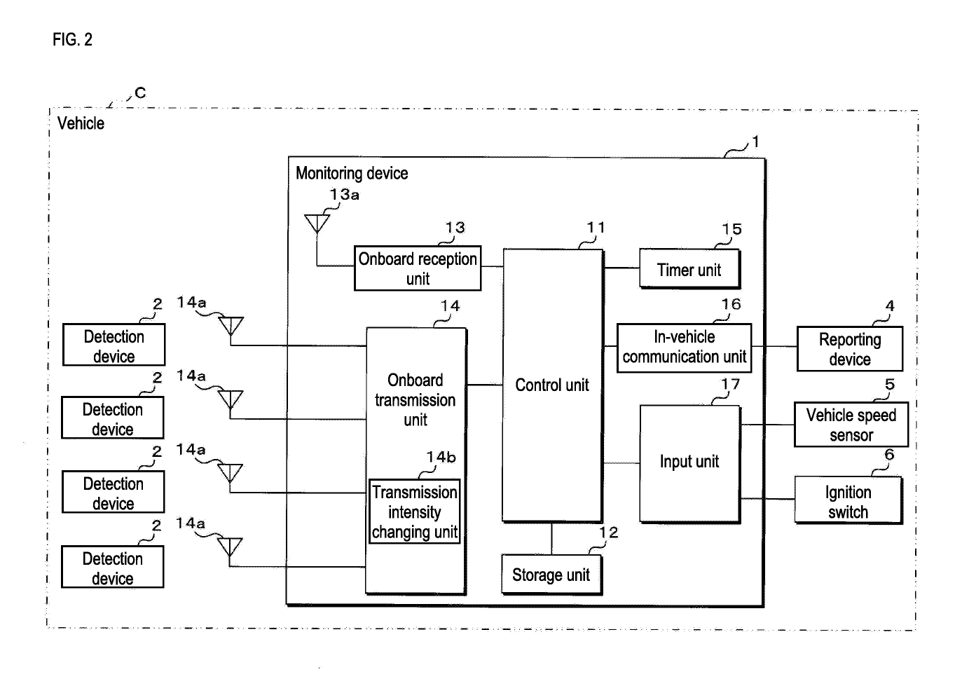

FIG. 2 is a block diagram showing an example of the configuration of the monitoring device 1. The monitoring device 1 includes a control unit 11 that controls operations of constituent units of the monitoring device 1. The control unit 11 is connected to a storage unit 12, an onboard reception unit 13, an onboard transmission unit 14, a timer unit 15, an in-vehicle communication unit 16, and an input unit 17.

The control unit 11 is a microcontroller that has one or more CPUs (Central Processing Units) or a multi-core CPU, a ROM (Read Only Memory), a RAM (Random Access Memory), an input/output interface, and the like. The CPU of the control unit 11 is connected to the storage unit 12, the onboard reception unit 13, the onboard transmission unit 14, the timer unit 15, the in-vehicle communication unit 16, and the input unit 17 via the input/output interface. By executing a control program stored in the storage unit 12, the control unit 11 controls the operations of the constituent units and executes sensor ID update processing and tire air pressure monitoring processing according to the present embodiment.

The storage unit 12 is a non-volatile memory such as an EEPROM (Electrically Erasable Programmable ROM) or a flash memory. The storage unit 12 stores a control program for the execution of sensor ID update processing and tire air pressure monitoring processing by the control unit 11 controlling the operations of the constituent units of the monitoring device 1. The storage unit 12 also stores a sensor ID table that stores the relationship between the four tire positions and the sensor IDs (identifiers) that identify the detection devices 2 of the tires 3 provided at the tire positions.

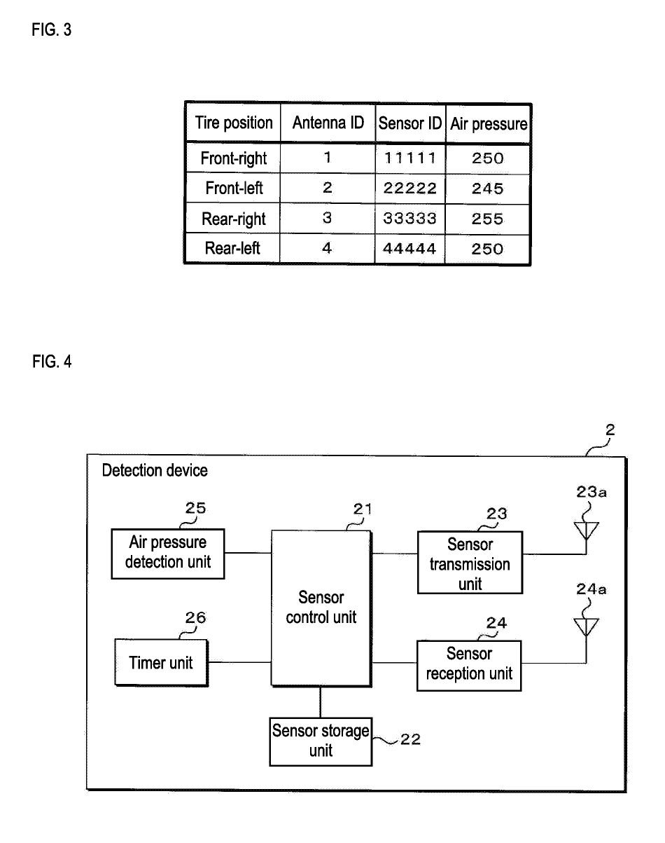

FIG. 3 is a conceptual diagram showing an example of a sensor ID table. The sensor ID table stores tire positions, antenna IDs for identifying the LF transmission antennas 14a, sensor IDs of the detection devices 2 provided on the tires 3 at the tire positions, and current air pressures detected by the detection devices 2, in association with each other. The air pressures are numerical values in units of kPa, for example.

The RF reception antenna 13a is connected to the onboard reception unit 13. The onboard reception unit 13 uses the RF antenna 13a to receive signals that are transmitted by the detection devices 2 using RF band radio waves. The onboard reception unit 13 is a circuit that demodulates the received signals and outputs the demodulated signals to the control unit 11. The 300 MHz to 3 GHz UHF band is used as the carrier wave, but the present disclosure is not limited to this frequency band.

The onboard transmission unit 14 is a circuit that modulates signals output by the control unit 11 into LF band signals, and transmits the modulated signals from the LF transmission antennas 14a to the respective detection devices 2. The 30 kHz to 300 kHz LF band is used as the carrier wave, but the present disclosure is not limited to this frequency band.

The onboard transmission unit 14 also includes a transmission intensity changing unit 14b that changes the transmission intensity of signals transmitted from the LF transmission antennas 14a. The transmission intensity changing unit 14b is an amplifier for example, and can change the transmission intensity of the request signals transmitted from the LF transmission antennas 14a under control of the control unit 11.

Hereinafter, among the request signals transmitted from the onboard transmission unit 14, a request signal that is mainly transmitted when checking consistency in the sensor ID table will be referred to as a first request signal, and a request signal that is transmitted when specifying sensor IDs that corresponds to tire positions in conventional statistical processing will be referred to as a second request signal.

The timer unit 15 is constituted by a timer, a real-time clock, or the like, and starts timing under control of the control unit 11 and gives a timing result to the control unit 11.

The in-vehicle communication unit 16 is a communication circuit that performs communication in accordance with a communication protocol such as CAN (Controller Area Network) or LIN (Local Interconnect Network), and is connected to the reporting device 4. The in-vehicle communication unit 16 transmits air pressure information regarding the tires 3 to the reporting device 4 under control of the control unit 11.

The reporting device 4 is, for example, a display unit or an audio device provided with a speaker that uses images or audio to report air pressure information regarding the tires 3 that was transmitted by the in-vehicle communication unit 16, or a display unit provided in a gauge in the instrument panel. Examples of the display unit include a liquid crystal display, an organic EL display, and a head-up display. For example, the reporting device 4 displays the air pressures of the tires 3 mounted to the vehicle C.

A vehicle speed sensor 5 and an ignition switch 6 are connected to the input unit 17.

The vehicle speed sensor 5 includes, for example, a non-contact sensor provided with a magnetic pickup, Hall element, or the like that sends a signal that is proportional to the rotation speed of the axle provided in the vehicle C, and a counting circuit that counts the number of pulses from the non-contact sensor, and the vehicle speed detection unit 5 detects the speed of the vehicle C by counting the number of pulses. The vehicle speed sensor 5 outputs a vehicle speed signal indicating the speed of the vehicle C to the input unit 17, and the control unit 11 can determine that the vehicle C is in a stopped state, a traveling start state, a traveling state, or the like based on the vehicle speed signal received from the input unit 17. The non-contact sensor is one example of the speed detection unit, and the present disclosure is not limited to this structure. For example, the vehicle speed sensor 5 may be configured to detect the speed of the vehicle C based on position information regarding the vehicle C that is detected by GPS.

The input unit 17 also receives an ignition signal (called an IG signal hereinafter) that indicates the on/off state of the ignition switch 6, and the control unit 11 can determine the on/off state of the ignition switch 6 based on the IG signal that was input to the input unit 17.

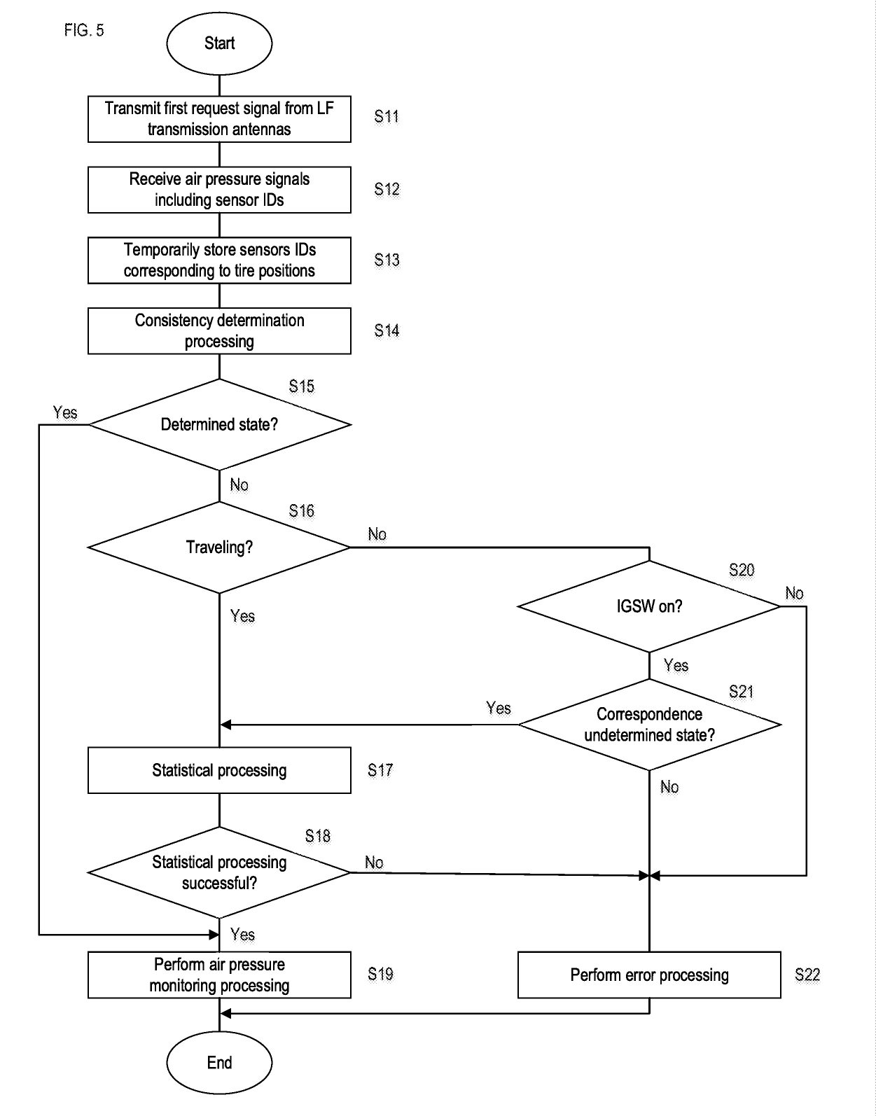

FIG. 4 is a block diagram showing an example of the configuration of a detection device 2. The detection device 2 includes a sensor control unit 21 that controls the operations of constituent units of the detection device 2. The sensor control unit 21 is connected to a sensor storage unit 22, a sensor transmission unit 23, a sensor reception unit 24, an air pressure detection unit 25, and a timer unit 26.

The sensor control unit 21 is a microcontroller that has one or more CPUs or a multi-core CPU, a ROM, a RAM, an input/output interface, and the like. The CPU of the sensor control unit 21 is connected to the sensor storage unit 22, the sensor transmission unit 23, the sensor reception unit 24, the air pressure detection unit 25, and the timer unit 26 via the input/output interface. The sensor control unit 21 reads out a control program stored in the sensor storage unit 22, and controls various units. The detection device 2 includes a battery (not shown), and operates using power from this battery.

The sensor storage unit 22 is a non-volatile memory. The sensor storage unit 22 stores a control program for the CPU of the sensor control unit 21 to perform processing related to the detection and transmission of the air pressure of a tire 3.

The air pressure detection unit 25 includes a diaphragm, for example, and detects the air pressure of the tire 3 based on a diaphragm deformation amount that varies according to the magnitude of pressure. The air pressure detection unit 25 outputs a signal indicating the detected air pressure of the tire 3 to the sensor control unit 21. By executing a control program, the sensor control unit 21 acquires the air pressure of the tire 3 from the air pressure detection unit 25, generates an air pressure signal that includes information indicating the air pressure, the unique sensor ID of the detection device 2, and the like, and outputs the air pressure signal to the sensor transmission unit 23.

Note that a temperature detection unit (not shown) that detects the temperature of a tire 3 and outputs a signal indicating the detected temperature to the sensor control unit 21 may be provided. In this case, the sensor control unit 21 generates an air pressure signal that includes information such as air pressure information, temperature information, and a sensor ID, and outputs this air pressure signal to the sensor transmission unit 23.

An RF transmission antenna 23a is connected to the sensor transmission unit 23. The sensor transmission unit 23 demodulates the air pressure signal that was generated by the sensor control unit 21 to obtain a UHF band signal, and transmits the demodulated air pressure signal with use of the RF transmission antenna 23a.

An LF reception antenna 24a is connected to the sensor reception unit 24. The sensor reception unit 24 uses the LF reception antenna 24a to receive a request signal that was transmitted from the monitoring device 1 using LF band radio waves, and outputs the received signal to the sensor control unit 21.

Next, a sensor ID table update processing procedure will be described.

FIG. 5 is a flowchart showing a sensor ID update processing procedure according to the first embodiment. The monitoring device 1 executes the following processing at a predetermined timing. For example, the execution of the following processing by the monitoring device 1 is triggered by the case where the ignition switch 6 changes from the off state to the on state. Also, the execution of the following processing may be triggered by the case where an accessory power supply changes from the off state to the on state, or the case where a battery power supply changes from the off state to the on state. The control unit 11 transmits the first request signal from the LF transmission antennas 14a (step S11). The control unit 11 then receives air pressure signals (step S12) that include sensor IDs and were transmitted from the detection devices 2 in accordance with the first request signals that were transmitted in step S11. The control unit 11 then temporarily stores the sensor IDs that correspond to the tire positions (step S13). For example, in the case of transmitting the first request signal from the LF transmission antenna 14a that is provided in the front-right portion of the vehicle C, the monitoring device 1 receives the sensor ID that is transmitted from a detection device 2 in accordance with the request signal, and temporarily stores this sensor ID as the sensor ID that corresponds to the front-right tire position. The sensor IDs are temporarily stored in a similar manner for the other tire positions as well.

Next, the control unit 11 executes a subroutine pertaining to consistency determination processing for determining consistency between the received sensor IDs corresponding to the tire positions and the sensor IDs that are registered in the sensor ID table in correspondence with the tire positions (step S14).

The following describes details of the consistency determination processing in step S14.

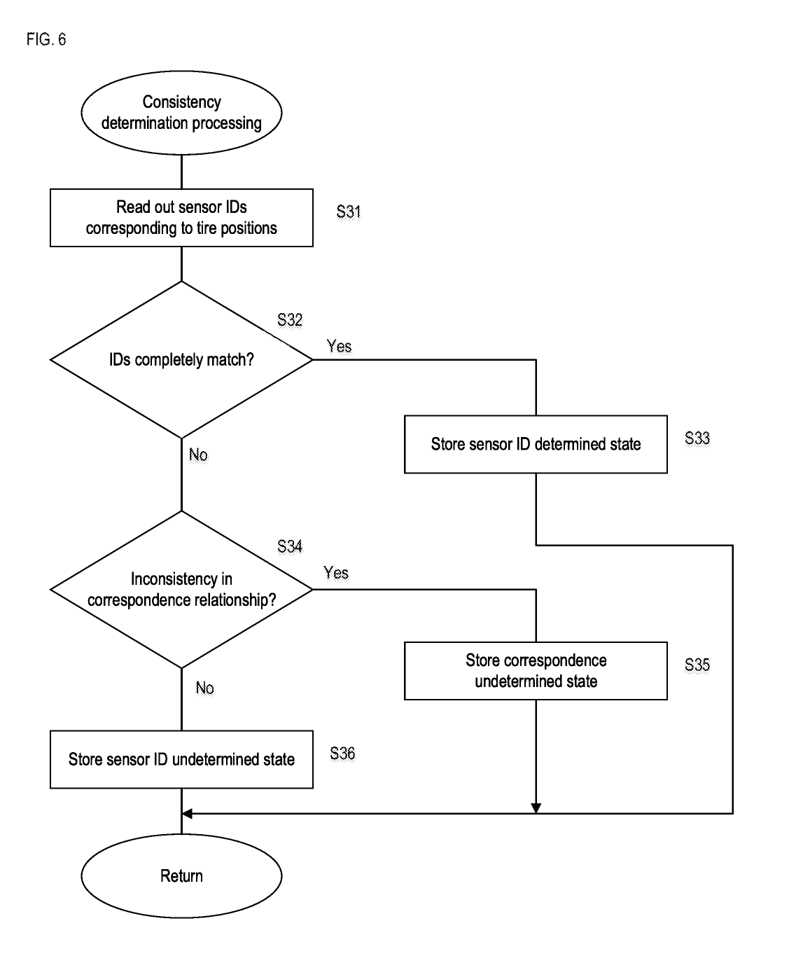

FIG. 6 is a flowchart showing a processing procedure of the subroutine pertaining to sensor ID consistency determination processing. Upon calling the subroutine pertaining to sensor ID consistency determination processing in step S14, the control unit 11 reads out the sensor IDs corresponding to the tire positions from the sensor ID table (step S31). Next, the control unit 11 determines whether or not the received and temporarily stored sensor IDs corresponding to the tire positions completely match, in one-to-one correspondence, the sensor IDs registered in the sensor ID table (step S32). The processing of step S32 corresponds to a first determination in this aspect.

If the sensor IDs completely match in one-to-one correspondence (step S32: YES), the control unit 11 stores the fact that the sensor IDs corresponding to the tire positions are determined (step S33), ends the processing of the subroutine pertaining to consistency determination processing, and then returns the processing to step S15. Hereinafter, the state where the sensor ID registered in the sensor ID table and the received sensor ID match in one-to-one correspondence for each tire position will be called the sensor ID determined state.

FIG. 7 is a table for describing the sensor ID determined state. As shown in FIG. 7, the LF transmission antennas 14a with antenna IDs “1”, “2”, “3”, and “4” correspond to the four front-right, front-left, rear-right, and rear-left tire positions. Also, the sensor IDs of the detection devices 2 provided in the four tires 3 at the tire positions are registered in the sensor ID table in association with the tire positions of the tires 3 that are provided with the detection devices 2. For example, the sensor ID “11111” is associated with the front-right tire position, the sensor ID “22222” is associated with the front-left tire position, the sensor ID “33333” is associated with the rear-right tire position, the sensor ID “44444” is associated with the rear-left tire position.

Also, “received sensor ID” in FIG. 7 indicates the received sensor IDs corresponding to the tire positions, and the sensor ID registered in the sensor ID table and the received sensor ID completely match in one-to-one correspondence for each tire position. Specifically, the sensor ID that is received after transmitting the first request signal from the LF transmission antenna 14a located at the front-right of the vehicle C is “11111”, and the sensor ID that is received after transmitting the first request signal from the LF transmission antenna 14a located at the front-left of the vehicle C is “22222”. Similarly, the sensor ID that is received after transmitting the first request signal from the LF transmission antenna 14a located at the rear-right of the vehicle C is “33333”, and the sensor ID that is received after transmitting the first request signal from the LF transmission antenna 14a located at the rear-left of the vehicle C is “44444”.

Returning to FIG. 6, if it was determined in step S32 that the sensor IDs do not match in one-to-one correspondence (step S32: NO), the control unit 11 determines whether or not there is currently a state where the received sensor IDs corresponding to the tire positions each match one of the sensor IDs registered in the sensor ID table, but the correspondence relationship with the tire positions is not consistent (step S34). The processing of step S34 corresponds to a second determination in this aspect. If it is determined that the correspondence relationship with the tire position is not consistent (step S34: YES), the fact that the correspondence between the tire positions and the sensor IDs is undetermined is stored (step S35), the processing of the subroutine pertaining to consistency determination is ended, and the processing is returned to step S15. Hereinafter, the state where the correspondence relationship between the tire positions and the sensor IDs is undetermined will be called the correspondence undetermined state as appropriate.

FIG. 8 is a table for describing the correspondence undetermined state for the tire positions and the sensor IDs. In FIG. 8, the tire positions, the antenna IDs, and the content of the sensor IDs stored by the storage unit 12 are similar to the table in FIG. 7.

“Received sensor ID” in FIG. 8 indicates the received sensor IDs corresponding to the tire positions, and the state exists where the four sensor IDs stored in the storage unit 12 and the four received sensor IDs completely match, but the correspondence relationship with the tire positions is not consistent. Specifically, the sensor ID that is received after transmitting the first request signal from the LF transmission antenna 14a located at the front-right of the vehicle C is “22222”, and the sensor ID that is received after transmitting the first request signal from the LF transmission antenna 14a located at the front-left of the vehicle C is “11111”. In this case, there is a possibility that the front-right tire 3 and the front-left tire 3 have been interchanged by performing tire rotation.

Returning to FIG. 6, if it is determined in step S34 that the received sensor IDs and the sensor IDs registered in the sensor ID table are different (step S34: NO), the control unit 11 stores the fact that the sensor IDs are undetermined (step S36), ends the processing of the subroutine pertaining to consistency determination processing, and returns the processing to step S15. Hereinafter, the state where a sensor ID corresponding to a tire position is undetermined will be called the sensor ID undetermined state as appropriate.

FIG. 9 is a table for describing the sensor ID undetermined state. In FIG. 9, the tire positions, the antenna IDs, and the content of the sensor IDs stored by the storage unit 12 are similar to the table in FIG. 7.

“Received sensor ID” in FIG. 9 indicates the received sensor IDs corresponding to the tire positions, and the state exists where a received sensor ID does not match with any of the four sensor IDs registered in the sensor ID table. Specifically, the sensor ID that was received after transmitting the first request signal form the LF transmission antenna 14a located at the front-left of the vehicle C is “77777”. In this case, there is a possibility that the front-left tire 3 was replaced with another tire 3 along with the detection device 2, or that the detection device 2 was replaced. There is also a possibility that the sensor ID “77777” received by the monitoring device 1 was transmitted from a detection device 2 of another vehicle C in response to the first request signal that was transmitted from the LF transmission antenna 14a provided in the front-left of the vehicle C.

Returning to FIG. 5, the following describes the processing performed by the control unit 11 after completion of the processing of the step S14.

After completing the processing of step S14, the control unit 11 references the determination result of step S14, and determines whether or not the sensor ID determined state is the current state (step S15). Upon determining that the sensor ID determined state is not the current state (step S15: NO), the control unit 11 determines whether or not the vehicle C is traveling based on the vehicle speed signal that was input to the input unit 17 (step S16). Upon determining that the vehicle C is traveling (step S16: YES), the control unit 11 executes a subroutine pertaining to statistical processing for specifying and updating a sensor ID corresponding to a tire position for which the receiving sensor ID and the sensor ID registered in the sensor ID table do not match (step S17). This statistical processing is processing for acquiring multiple sensor IDs by transmitting the second request signal to the detection devices 2 provided at the tire positions, and statistically specifying and updating the sensor IDs for the tires 3. The term “specify” used here means statistically obtaining the correct or likely sensor ID of the detection device 2 provided at a certain tire position. Details of the subroutine pertaining to statistical processing will be described later.

Next, the control unit 11 determines whether or not the statistical processing of step S17 pertaining to sensor ID specification and updating was successful (step S18). For example, it is sufficient that the control unit 11 determines whether or not the statistical processing was successful based on a later-described return value of the subroutine pertaining to statistical processing. Specifically, if, for example, the sensor ID corresponding to even one of the four tire positions is undetermined and cannot be updated, the control unit 11 determines that the specification and updating failed, whereas if the sensor IDs corresponding to all of the tire positions are determined and could be updated, the control unit 11 determines that the specification and updating was successful. If it is determined that the specification of the sensor IDs failed (step S18: NO), predetermined error processing is executed (step S22), and this processing is ended. For example, the control unit 11 issues an error message by transmitting to the reporting device 4 an error signal indicating that the air pressure information of the tires 3 could not be obtained. Also, a configuration is possible in which if any of the air pressures indicated by the air pressure information received in step S12 is lower than a threshold value, the control unit 11 causes the reporting device 4 to report the fact that the air pressure of one of the tires is abnormal. Note that a configuration is possible in which if it is determined that the specification of the sensor IDs failed, the processing is returned to step S16, and the statistical processing of step S17 is executed during traveling after a predetermined time has elapsed.

Upon determining that the statistical processing for specifying the sensor IDs corresponding to the tire positions was successful (step S18: YES), or upon determining in step S15 that the sensor ID determined state is the current state (step S15: YES), the control unit 11 executes processing for monitoring the air pressures of the tires 3 provided at the tire positions with use of the sensor ID table (step S19), and then ends this processing. Specifically, the control unit 11 executes processing for notifying the air pressure information of the tires 3 by transmitting the air pressure information of the tires 3 to the reporting device 4. Also, the control unit 11 determines whether or not the air pressures of the tires 3 are higher than or equal to a threshold value, and if a tire 3 that is below the threshold value exists, the control unit 11 executes processing for issuing a warning by transmitting to the reporting device 4 information indicating that the air pressure of that tire 3 is below the threshold value.

Note that needless to say, the air pressure monitoring processing may be executed at not only the timing when the ignition switch 6 changes from the off state to the on state, but also in a continuous manner at desired timings during traveling of the vehicle C or during engine operation. Also, in this case, a configuration is possible in which the processing is returned to step S11 at a predetermined timing, and the sensor IDs corresponding to the tire positions are updated.

Upon determining that the vehicle C is not traveling (step S16: NO), the control unit 11 determines whether or not the ignition switch 6 is in the on state based on the IG signal that was input to the input unit 17 (step S20). Upon determining that the ignition switch 6 is not in the on state (step S20: NO), the control unit 11 executes predetermined error processing (step S22), and ends this processing. Note that a configuration is possible in which upon determining that the ignition switch 6 is not in the on state, the control unit 11 returns the processing to step S16, waits until the vehicle C starts to travel, and executes the statistical processing of step S17 after traveling has started.

Upon determining that the ignition switch 6 is in the on state (step S20: YES), the control unit 11 references the determination result of step S14 and determines whether or not the current state is the correspondence undetermined state where the correspondence relationship of the tire positions and the sensor IDs is undetermined (step S21). Upon determining that the correspondence undetermined state is the current state (step S21: YES), the control unit 11 executes statistical processing for specifying and updating a sensor ID corresponding to a tire position for which the receiving sensor ID and the sensor ID registered in the sensor ID table do not match (step S17).

If it is determined that the correspondence undetermined state is not the current state (step S21: NO), that is to say if it is determined that the current state is the sensor ID undetermined state where a received sensor ID does not correspond to any of the sensor IDs stored in the storage unit 12, and that the vehicle C is in the stopped state, predetermined error processing is executed (step S22), and this processing is ended. Note that a configuration is possible in which if the sensor ID undetermined state is the current state, and the vehicle C is in the stopped state, the control unit 11 returns the processing to step S16, waits until the vehicle C starts to travel, and executes the statistical processing of step S17 after traveling has started.

The following describes statistical processing in which if a received sensor ID corresponding to a tire position does not match a sensor ID registered in the sensor ID table, the sensor ID corresponding to that tire position is specified and updated.

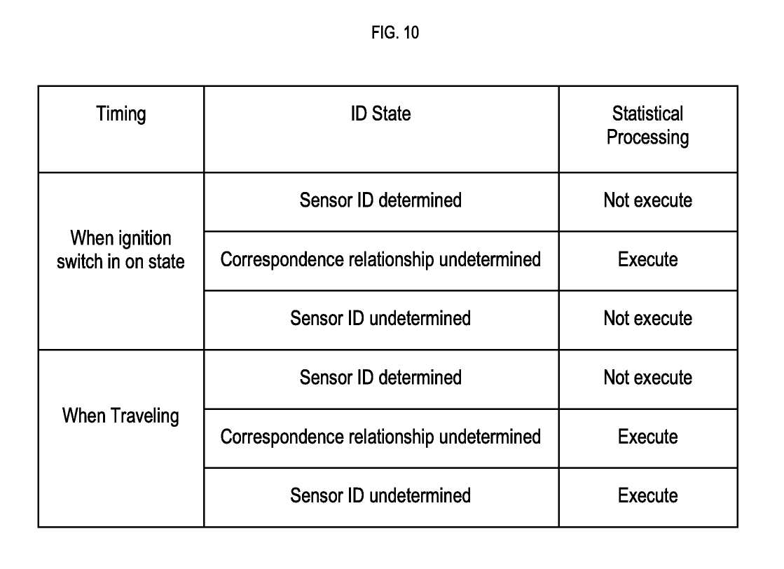

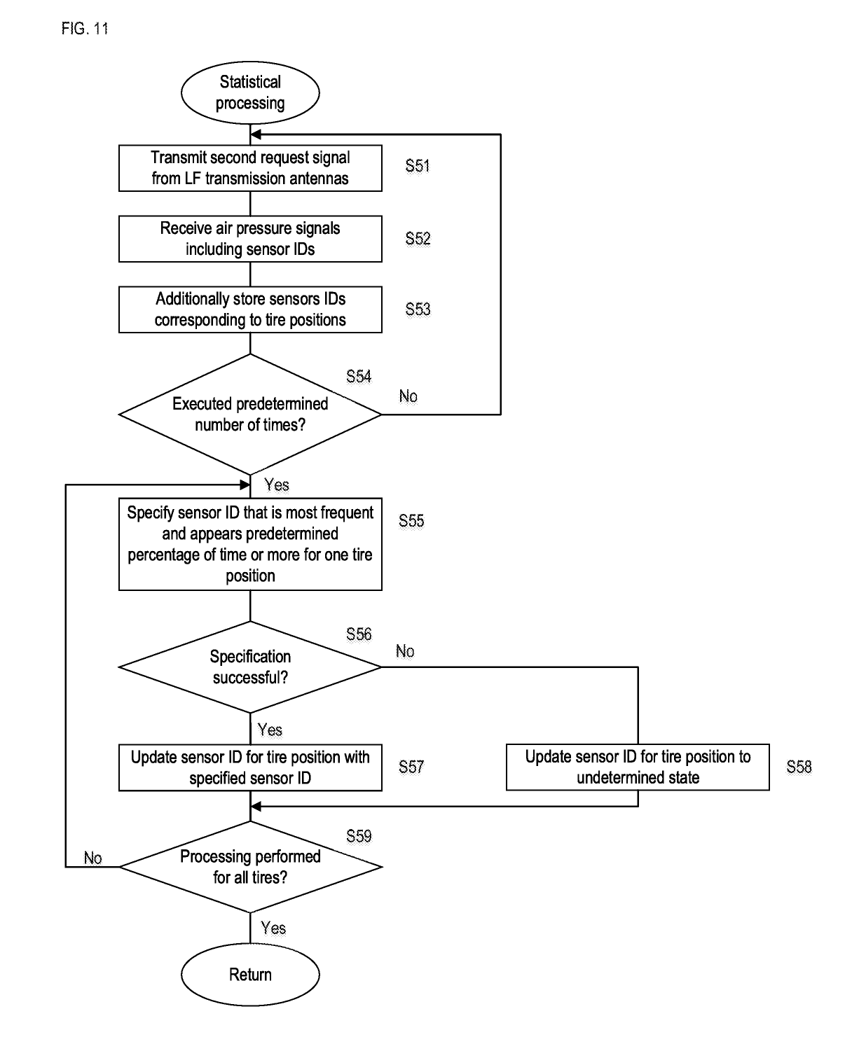

FIG. 10 is a table showing timings at which statistical processing is to be performed. In the first embodiment, as shown in FIG. 10, the monitoring device 1 executes statistical processing pertaining to sensor ID specification when the ignition switch 6 changes to the on state, and when the vehicle C is traveling. It should be noted that because the statistical processing needs to be executed in a situation where the sensor IDs corresponding to the tire positions can be received with a certain probability, the timing suited to statistical processing differs according to the type of state in which sensor IDs are not consistent. The center column in the table shown in FIG. 10 indicates the type of sensor ID inconsistent state, and the right-side column indicates whether or not statistical processing is to be executed. If the sensor ID determined state is the current state, it goes without saying that the statistical processing is not necessary, and the statistical processing is not executed.

In the state where the correspondence relationship of the tire positions and the sensor IDs is not determined, it was not possible to receive a sensor ID that was transmitted by the detection device 2 of at least one of the tires 3 provided in the own vehicle C, and therefore statistical processing can be performed both when the ignition switch 6 is in the on state and when the vehicle C is traveling.

However, in the sensor ID undetermined state, there is a possibility that a sensor ID transmitted by a detection device 2 of another vehicle C has been received, and therefore even if the vehicle C is in the stopped state, there is a risk that the sensor IDs corresponding to the tire position cannot be correctly specified by the statistical processing. For this reason, it is preferable that in the sensor ID undetermined state, the monitoring device 1 performs statistical processing if the vehicle C is traveling and the positional relationship between the own vehicle C and the other vehicle C has changed. Accordingly, in the sensor ID undetermined state, even if the ignition switch 6 is in the on state, the monitoring device 1 does not execute statistical processing if the vehicle C is not yet traveling.

FIG. 11 is a flowchart showing a processing procedure of a subroutine pertaining to statistical processing for specifying and updating sensor IDs. Upon calling the subroutine pertaining to statistical processing in step S17, the control unit 11 transmits the second request signal from the LF transmission antennas 14a (step S51). The control unit 11 then receives air pressure signals (step S52) that include sensor IDs and were transmitted from the detection devices 2 in accordance with the second request signals that were transmitted in step S51. The control unit 11 then adds the sensor IDs that correspond to the tire positions as samples (step S53). Next, the control unit 11 determines whether or not the second request signal transmission and sensor ID reception processing has been executed a predetermined number of times for each of the LF transmission antennas 14a (step S54). Upon determining that the second request signal transmission and sensor ID reception processing has not been executed the predetermined number of times (step S54: NO), the control unit 11 returns the processing to step S51.

Upon determining that the second request signal transmission and sensor ID reception processing have been executed the predetermined number of times (step S54: YES), the control unit 11 specifies the sensor ID that is the most frequent and appears a predetermined percentage of the time or more as the sensor ID that corresponds to a tire position (step S55), based on the sensor IDs that were temporarily stored in the processing of step S13 and the sensor IDs that were additionally stored in the processing of steps S51 to S54. For example, in the processing of step S13, the monitoring device 1 transmits the first request signal one time from the LF transmission antenna 14a at the front-right of the vehicle C, and temporarily stores the sensor ID that was transmitted from the detection device 2 in response to the first request signal, in correspondence with the front-right tire position. Also, in the processing of steps S51 to S54, the monitoring device 1 transmits the second request signal multiple times from the LF transmission antenna 14a at the front-right of the vehicle C, and additionally stores the sensor IDs that were transmitted from the detection device 2 in response to the second request signals, in correspondence with the front-right tire position. In step S55, the control unit 11 specifies the sensor ID that is the most frequent and appears a predetermined percentage of the time or more from among the temporarily stored and additionally stored sensor IDs that correspond to the front-right tire position. Specifically, upon additionally storing a sensor ID two times, the control unit 11 specifies the sensor ID that is the most frequent and appears the predetermined percentage of the time or more from among the total of three sensor IDs including the temporarily stored sensor ID. The sensor ID that is the most frequent and appears the predetermined percentage of the time or more is the sensor ID that has the highest reception frequency among the received sensor IDs, and for which the percentage of the time the sensor ID appears among the received sensor IDs is the predetermined percentage or more.

Note that although the case where the predetermined number of times is two or more times is described above, the predetermined number of times may be one time. In the case where the predetermined number of times is one time, the processing of step S54 may be omitted. In the case where the predetermined number of times is one time, the control unit 11 determines the sensor ID that is the most frequent and appears the predetermined percentage of the time or more out of a total of two sensor IDs including the one additionally stored sensor ID and the one temporarily stored sensor ID.

Next, the control unit 11 determines whether or not the sensor ID specification was successful, that is to say whether or not a sensor ID that is the most frequent and appears the predetermined percentage of the time or more was specified (step S56). If it was determined that a sensor ID was specified (step S56: YES), the sensor ID corresponding to the one tire position in the sensor ID table is updated (step S57) with the sensor ID that was specified in step S55. Here, the term “update” means a sensor ID registered in the sensor ID table being overwritten by another sensor ID. This other sensor ID is the sensor ID that is most likely to be the sensor ID of the detection device 2 provided at the tire position.

Upon determining that sensor ID specification failed (step S56: NO), the control unit 11 updates the sensor ID corresponding to the one tire position in the sensor ID table to the undetermined state (step S58).

After the processing of step S57 or S58 is complete, the control unit 11 determines whether or not the processing for sensor ID updating in step S57 or for updating to the undetermined state in step S58 is complete for all of the tire positions (step S59). Upon determining that the processing of step S57 or S58 has not been performed for a tire position (step S59: NO), the control unit 11 returns the processing to step S55. Upon determining that the processing of step S59 or S60 is complete for all of the tire positions (step S59: YES), the control unit 11 ends the processing of the subroutine pertaining to statistical processing, and returns the processing to step S18. In the statistical processing subroutine, if even one sensor ID corresponding to a tire position could not be specified or updated, a variable indicating that statistical processing failed is set as the return value, and the processing of the subroutine is ended. In the statistical processing subroutine, if the sensor IDs corresponding to all of the tire positions are specified and updated, a variable indicating that statistical processing was successful is set as the return value, and the processing of the subroutine is ended.

For example, with respect to one tire position, if the sensor ID that was temporarily stored in step S13 is 1111, and the sensor ID that was additionally acquired two times in step S53 is 1112, the most frequent ID is 1112. If the predetermined percentage is 60%, the most frequent sensor ID 1112 that was acquired two times among the three sensor IDs appears the 60% of the time or more, and therefore 1112 is registered as the correct sensor ID in the ID data table.

According to the tire air pressure monitoring system of first embodiment having this configuration, even if tire rotation, tire 3 replacement, or detection device 2 replacement is performed, or even if a sensor ID transmitted by another vehicle C is received, it is possible to unmistakingly specify the sensor IDs that correspond to the tire positions, and update the sensor IDs that are registered in the sensor ID table.

Also, in the processing of steps S55 to S58 of the statistical processing, the sensor ID that is the most frequent and appears the predetermined percentage of the time is specified, and therefore it is possible to achieve higher precision when unmistakingly specifying the sensor IDs that correspond to the tire positions and updating the sensor IDs that are registered in the sensor ID table.

Furthermore, the monitoring device 1 registers the correspondence relationship between the tire positions and the sensor IDs of the detection devices 2 provided at the tire positions in the sensor ID table, thus making it possible to check and update the content of the sensor ID table at a predetermined timing.

Accordingly, even if tire rotation or tire 3 replacement is performed, the sensor IDs that are registered in the sensor ID table in correspondence with the tire positions can be automatically updated.

Furthermore, if the ignition switch 6 changes from the off state to the on state, or at the timing when the vehicle C starts to travel, it is possible to check the content of the sensor ID table and automatically update the sensor IDs that are registered in the sensor ID table in correspondence with the tire positions.

Furthermore, if the tire positions and the sensor IDs are in the correspondence undetermined state, when the ignition switch 6 changes to the on state or the vehicle C is traveling, it is possible to statistically specify the sensor IDs that correspond to the tire positions and update the content of the sensor ID table.

Furthermore, if the sensor ID undetermined state is the current state, when the vehicle C is traveling, it is possible to specify the sensor IDs that correspond to the tire positions more accurately, and update the content of the sensor ID table.

Note that in the first embodiment, a configuration is described in which even when performing statistical processing, the monitoring device 1 receives the air pressure signals that include air pressure information and sensor IDs, but a configuration is possible in which when performing statistical processing, only the sensor IDs are requested from the detection devices 2, and only the sensor IDs are received.

Also, in the first embodiment, a configuration is mainly described in which the monitoring device 1 transmits request signals to the detection devices 2 provided in the tires 3 and receives air pressure signals, but a configuration is possible in which the detection devices 2 voluntarily detect the air pressures of the tires 3 and transmit air pressure signals indicating the detected air pressures and sensor IDs to the monitoring device 1. In this case, the monitoring device 1 references the sensor ID table with use of the sensor IDs included in the air pressure signal, and specifies the tire positions that correspond to the detection devices 2 that transmitted the air pressure signals. Accordingly, the monitoring device 1 can recognize the tire air pressure for each tire, and can monitor the air pressure of each tire.

Furthermore, the sensor ID updating processing performed by the statistical processing shown in FIG. 11 is not limited to being performed at the timing described in the first embodiment, and the sensor ID updating processing performed by the statistical processing in FIG. 11 may be performed on its own at any timing.

Furthermore, in the first embodiment, the sensor ID that is the most frequent and appears the predetermined percentage of the time or more is extracted through statistical processing and specified as the sensor ID that correctly or likely corresponds to a tire position, but there is no limitation to this method, and the correct or likely sensor ID may be specified using various methods. For example, it is not necessarily required to calculate a percentage, and sensor ID updating may be performed if the number of times that the most frequent sensor ID was acquired is a predetermined number or higher. Also, a configuration is possible in which when the most frequent sensor ID is selected, updating is performed using that most frequent sensor ID without giving consideration to the percentage. Furthermore, a configuration is possible in which if the sensor IDs that are received are all the same, the sensor ID table is updated using that sensor ID.

Furthermore, in the first embodiment, an example is described in which step S55 is performed with use of the sensor ID that was temporarily stored in the processing of step S13 and the sensor IDs that were additionally stored in the processing of steps S51 to S54, but a configuration is possible in which the sensor ID that was temporarily stored in the processing of step S13 is not used, and the most frequent sensor ID is specified using only the sensor IDs that were additionally stored in the processing of steps S51 to S54.

Furthermore, the first embodiment describes an embodiment mainly pertaining to a tire air pressure monitoring system, but hardware pertaining to wireless communication in the tire air pressure monitoring system may be used in another communication system as well. For example, it is possible to share hardware pertaining to wireless communication and configure both a vehicular communication system for TPMS and a passive entry system.

A passive entry system is constituted by the monitoring device 1 and a portable device related to the passive entry system. The monitoring device 1 performs wireless communication with the portable device in the possession of a user, authorizes the portable device, and detects the position of the portable device. A touch sensor (not shown) is provided in a door handle of the vehicle C, and if it is detected by the touch sensor that the user's hand touched the door handle, or if a door switch is pressed, for example, the monitoring device 1 executes processing such as locking and unlocking a door of the vehicle C when an authorized portable device is located outside of the vehicle. When performing wireless communication with the portable device, the monitoring device 1 sets a high transmission intensity for signals that are transmitted from the LF transmission antennas 14a, and when transmitting request signals to the detection devices 2, the monitoring device 1 sets a low transmission intensity for signals that are transmitted from the LF transmission antennas 14a.

Note that the passive entry system constituting the vehicular communication system is one example, the present disclosure can be applied to systems that perform various types of vehicle control through wireless communication between a portable device and the monitoring device 1. For example, the vehicular communication system may be constituted as, for example, a keyless entry system, or a smart start system that enables starting the motor in the vehicle without using a mechanical key, along with the TPMS.

### Second Embodiment

A tire air pressure monitoring system according to a second embodiment has a configuration similar to that of the first embodiment, and the processing for adjusting the transmission intensity of the request signals transmitted from the LF transmission antennas 14a is different from the first embodiment, and therefore the following description will focus mainly on this difference. Other configurations, actions, and effects are similar to those of the first embodiment, and therefore corresponding portions will be denoted by the same reference signs, and detailed descriptions will not be given for them.

The monitoring device 1 according to the second embodiment executes the following processing if the current state is the sensor ID undetermined state and the vehicle C is not traveling or the statistical processing fails. In the sensor ID undetermined state, there is a possibility that a tire 3 or a detection device 2 has been replaced, and there is a possibility that a sensor ID transmitted by a detection device 2 of another vehicle C has been received. However, by executing the following processing and adjusting the transmission intensity of the LF transmission antennas 14a, it is possible to eliminate the possibility that a sensor ID transmitted by a detection device 2 of another vehicle C has been received, and it is possible to confirm that a tire 3 has been replaced. Also, when statistical processing has failed, by executing the following processing and adjusting the transmission intensity of the LF transmission antennas 14a, it is possible to create a situation in which the statistical processing is likely to succeed.

The storage unit 12 of the monitoring device 1 according to the second embodiment stores a sensor ID table that registers not only tire positions and sensor IDs, but also transmission intensities used when transmitting request signals from the LF transmission antennas 14a to corresponding detection devices 2.

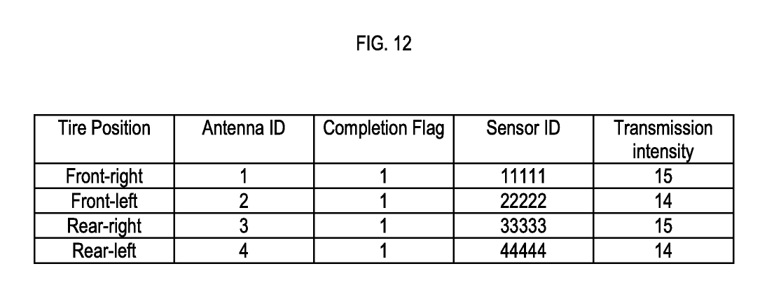

FIG. 12 is a conceptual diagram showing an example of the sensor ID table according to the second embodiment. In the sensor ID table, tire positions, antenna IDs for identifying the LF transmission antennas 14a, completion flags indicating whether or not the adjustment of transmission intensities for request signal is complete, sensor IDs that identify the detection devices 2 that correspond to the LF transmission antennas 14a, and request signal transmission intensities are registered in correspondence with each other.

A value of “1” for the completion flag indicates that transmission intensity adjustment is complete, and a value of “0” indicates the transmission intensity adjustment is not complete. The completion flag is reset to “0” when the ignition switch 6 changes from the off state to the on state, for example.

The request signal transmission intensity is expressed by a transmission power, and the transmission power here is divided in multiple levels, and numbers indicating the transmission intensity levels are registered in the sensor ID table.

Next, a processing procedure for adjusting the transmission intensity for a request signal will be described.

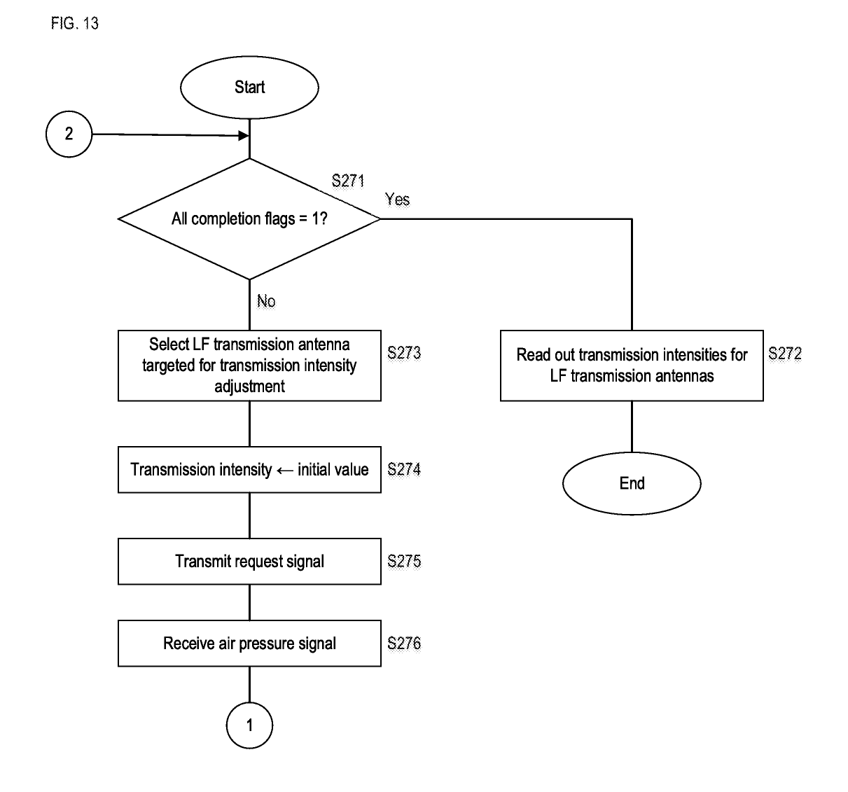

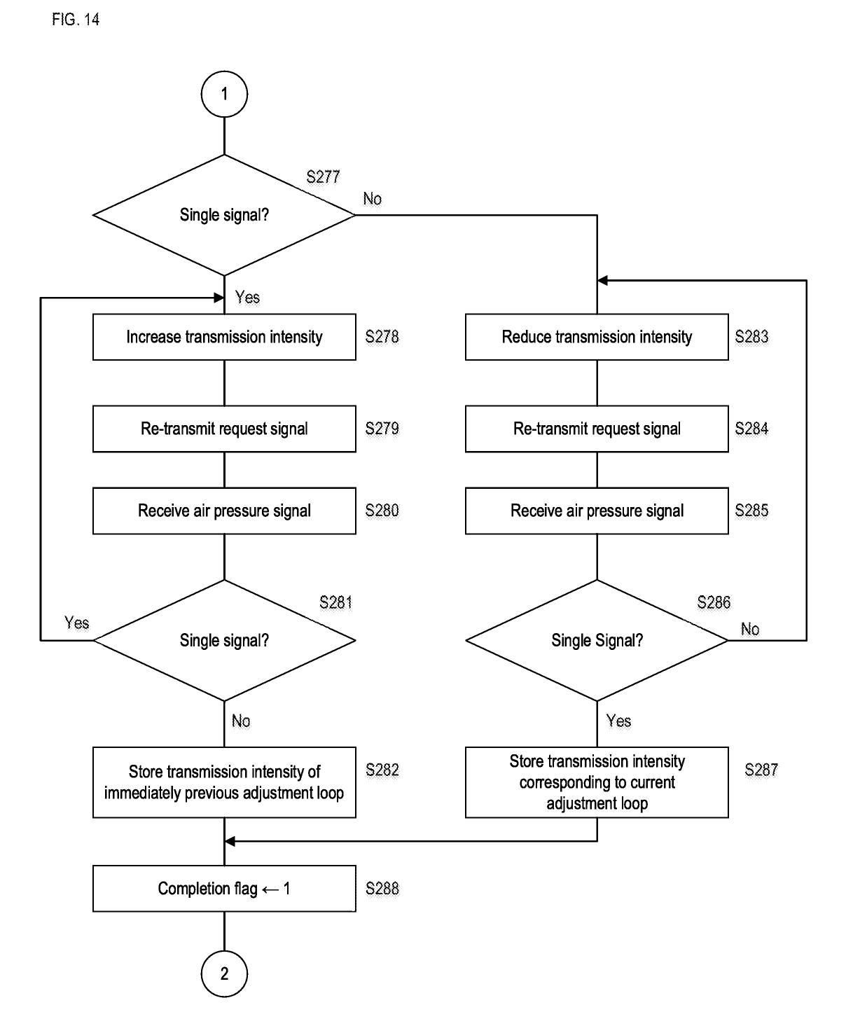

FIGS. 13 and 14 are flowcharts showing the transmission intensity adjustment processing procedure according to the second embodiment. The control unit 11 determines whether or not the completion flags for the LF transmission antennas 14a are all on with the value “1” (step S271). Upon determining that the completion flags for all of the LF transmission antennas 14a are on with the value “1” (step S271: YES), the control unit 11 reads out, from the storage unit 12 (i.e., the sensor ID table), the transmission intensities that are stored in the storage unit 12 in correspondence with the LF transmission antennas 14a (step S272), and then ends the request signal transmission intensity adjustment processing.

Upon determining that the completion flag for an LF transmission antenna 14a is off with the value “0” (step S271: NO), the control unit 11 selects an LF transmission antenna 14a for which the completion flag is set to “0”, that is to say an LF transmission antenna 14a that is to be subjected to transmission intensity adjustment (step S273). The control unit 11 then sets a predetermined initial value as the transmission intensity for the selected LF transmission antenna 14a (step S274). Next, the control unit 11 transmits a request signal (step S275) with the transmission intensity that was set in step S274 from the LF transmission antenna 14a that was selected in step S273. The control unit 11 then receives an air pressure signal (step S276) that is transmitted from a detection device 2 in accordance with the request signal that was transmitted in step S275.

Upon completing the processing of step S276, the control unit 11 determines whether or not a single air pressure signal was received in a predetermined time from when the request signal was transmitted (step S277). Upon determining that a single air pressure signal was received (step S277: YES), the control unit 11 increases the request signal transmission intensity by a predetermined amount (step S278). The control unit 11 then re-transmits the request signal (step S279) with the increased transmission intensity from the LF transmission antenna 14a that was selected in step S273.

Next, the control unit 11 receives an air pressure signal (step S280) that is transmitted from a detection device 2 in accordance with the request signal that was retransmitted in step S279. The control unit 11 then determines whether or not a single air pressure signal was received in a predetermined time from when the request signal was retransmitted (step S281). Upon determining that a single air pressure signal was received (step S281: YES), the control unit 11 returns the processing to step S278, and repeatedly executes processing for increasing the request signal transmission intensity until multiple air pressure signals are received.

Upon determining that multiple air pressure signals were received (step S281: NO), the control unit 11 selects the transmission intensity corresponding to the transmission intensity adjustment processing of the immediately previous loop as the transmission intensity for the LF transmission antenna 14a that is targeted for adjustment, and stores the selected transmission intensity in the storage unit 12 (step S282). Specifically, the storage unit 12 registers the antenna ID for identifying the LF transmission antenna 14a targeted for adjustment and the transmission intensity corresponding to the adjustment processing of the immediately previous loop in the sensor ID table in correspondence with each other.

Upon determining in step S277 that a single air pressure signal was not received (step S277: NO), the control unit 11 reduces the request signal transmission intensity by a predetermined amount (step S283). The control unit 11 then re-transmits the request signal (step S284) with the reduced transmission intensity from the LF transmission antenna 14a that was selected in step S273.

Next, the control unit 11 receives an air pressure signal (step S285) that is transmitted from a detection device 2 in accordance with the request signal that was retransmitted in step S284. The control unit 11 then determines whether or not a single air pressure signal was received in a predetermined time from when the request signal was retransmitted (step S286). Upon determining that a single air pressure signal was not received (step S286: NO), the control unit 11 returns the processing to step S283, and repeatedly executes processing for reducing the request signal transmission intensity until a single air pressure signal is received.

Upon determining that a single air pressure signal was received (step S286: YES), the control unit 11 selects the transmission intensity corresponding to the current transmission intensity adjustment as the transmission intensity for the LF transmission antenna 14a that is targeted for adjustment, and stores the selected transmission intensity in the storage unit 12 (step S287). Specifically, the storage unit 12 registers the antenna ID for identifying the LF transmission antenna 14a targeted for adjustment and the transmission intensity corresponding to the current adjustment in the sensor ID table in correspondence with each other.

Upon completing the processing of step S282 or step S287, the control unit 11 sets the completion flag for the LF transmission antenna 14a that was subjected to transmission intensity adjustment to “1” (step S288), and then returns the processing to step S271.

According to the tire air pressure monitoring system of the second embodiment having this configuration, the monitoring device 1 changes the request signal transmission intensity such that a response is received from a single detection device 2 in response to a request signal that was transmitted from each of the LF transmission antennas 14a, thus making it possible to reliably receive air pressure signals that are transmitted by the detection devices 2 of the tires 3 that are provided at the tire positions.

Accordingly, in the sensor ID undetermined state, even if the vehicle C is not traveling, the monitoring device 1 can specify a state in which a tire 3 has been replaced, and can update the sensor ID table.

Also, if the statistical processing fails, by adjusting the transmission intensities of the LF transmission antennas 14a, it is possible to improve the probability of successful sensor ID specification through statistical processing.

Note that in the second embodiment, an example is described in which the request signal transmission intensity is increased until multiple air pressure signals are received in steps S278 to S281, but the number of times that the transmission intensity is increased may be limited to a predetermined number of times. The predetermined number of times may be one time, or may be multiple times.

Also, a configuration is possible in which when reducing the transmission intensity in steps S283 to S286, after receiving a single air pressure signal, the transmission intensity is further reduced a predetermined number of times.

1. A monitoring device that monitors air pressures of tires, the monitoring device receiving air pressure signals transmitted from a plurality of detection devices that are respectively provided in a plurality of tires of a vehicle and wirelessly transmit air pressure signals each including a respective identifier and air pressure information obtained by detecting an air pressure of a respective tire, the monitoring device comprising:
a storage unit that stores a plurality of tire positions at which the plurality of tires are respectively provided and identifiers of the detection devices provided at the tire positions in correspondence with each other;
a request signal transmission unit that transmits, a plurality of times, a request signal requesting an identifier of a detection device to at least one of the tire positions;
an identifier reception unit that receives an identifier that was transmitted by a detection device in accordance with the request signal;
a specification unit that specifies an identifier of the detection device provided at the at least one tire position to which the request signal was transmitted, based on a plurality of identifiers that were transmitted by the detection device in accordance with the request signal that was transmitted a plurality of times; and
an updating unit that updates the identifier that is stored by the storage unit in correspondence with the at least one tire position to the identifier that was specified by the specification unit,
wherein the request signal includes a first request signal and a second request signal,
the request signal transmission unit transmits the first request signal to each of the plurality of tire positions, and the identifier reception unit receives a plurality of identifiers that were transmitted by the plurality of detection devices in accordance with the first request signal,
the monitoring device further includes:
a determination unit that makes a first determination for determining whether or not a correspondence relationship between the plurality of tire positions to which the first request signal was transmitted and the plurality of identifiers that were received by the identifier reception unit matches a correspondence relationship between the plurality of tire positions and the identifiers stored by the storage unit, and makes a second determination for determining whether or not each of the plurality of identifiers received by the reception unit matches any of the plurality of identifiers stored by the storage unit;
a switch state determination unit that determines whether or not an ignition switch of the vehicle is in an on state; and
a traveling state determination unit that determines whether or not the vehicle is traveling,
the request signal transmission unit transmits the second request signal in a case where the ignition switch is in the on state, a determination result of the first determination a non-match, and a determination result of the second determination is a match, or in a case where the vehicle is traveling and a determination result of the first determination or the second determination is a non-match, and
the specification unit specifies the identifier of the detection device provided at the at least one tire position based on the plurality of identifiers that were transmitted by the detection device in accordance with at least one of the first request signal and the second request signal.

2. The monitoring device according to claim 1, wherein in a case where one identifier appears a predetermined percentage of time or more among the received plurality of identifiers, the specification unit specifies the one identifier as the identifier of the detection device provided at the at least one tire position at which the request signal was transmitted.

3-8. (canceled)

9. A tire air pressure monitoring system comprising:
a plurality of detection devices that are respectively provided in a plurality of tires of a vehicle and wirelessly transmit air pressure signals each including a respective identifier and air pressure information obtained by detecting an air pressure of a respective tire; and
the monitoring device according to claim 1,
wherein the monitoring device receives the air pressure signals transmitted by the plurality of detection devices and monitors air pressures of the tires.

10. A tire air pressure monitoring system comprising:
a plurality of detection devices that are respectively provided in a plurality of tires of a vehicle and wirelessly transmit air pressure signals each including a respective identifier and air pressure information obtained by detecting an air pressure of a respective tire; and
the monitoring device according to claim 2,
wherein the monitoring device receives the air pressure signals transmitted by the plurality of detection devices and monitors air pressures of the tires.
